(19) United States
(12) Patent Application Publication
(10) Pub. No.: US 2022/0080998 A1
(43) Pub. Date: Mar. 17, 2022

(54) APPARATUS AND METHOD FOR DETERMINING POSITION OF VEHICLE

(71) Applicants: Hyundai Motor Company, Seoul (KR); Kia Corporation, Seoul (KR)

(72) Inventor: Young Suk Kim, Seoul (KR)

(73) Assignees: Hyundai Motor Company, Seoul (KR); Kia Corporation, Seoul (KR)

(21) Appl. No.: 17/346,599

(22) Filed: Jun. 14, 2021

(30) Foreign Application Priority Data
Sep. 16, 2020 (KR) 10-2020-0119043

(51) Int. Cl. B60W 60/00; G06K 9/62

(52) U.S. Cl. CPC B60W 60/001; G06K 9/6288; B60W 2520/14; B60W 2420/52; B60W 2554/4041

(57) ABSTRACT

An apparatus of determining a position of a vehicle, may include a plurality of sensors to acquire raw data for vehicle information and surrounding information related to the vehicle, and a controller to generate a plurality of vehicle position point data based on the raw data, generate respective tracklets for the sensors by combining the plurality of vehicle position point data, fuse the tracklets for the sensors, and determine a final position of the vehicle using the fused tracklets for the sensors. The position is exactly estimated, and a computation amount is prevented from being excessively increased such that real-time position information is easily acquired

### CROSS-REFERENCE TO RELATED APPLICATION

The present application claims priority to Korean Patent Application No. 10-2020-0119043, filed on Sep. 16, 2020, the entire contents of which is incorporated herein for all purposes by this reference.

### BACKGROUND OF THE INVENTION

### Field of the Invention

The present invention relates to an apparatus and a method for determining a position of a vehicle.

### Description of Related Art

For autonomous driving of a vehicle, it is very important to determine the exact position of the vehicle in a global path range for fully autonomous driving of the vehicle and a local path range partially having an unpaved road. Currently, the position of the vehicle has been determined through the fusion of a global navigation satellite system (GNSS) and an inertia sensor (INS), which makes it easy to determine the position of the vehicle in the global path range. However, when only the above-described manner is employed, there is a limitation in determining the position of the vehicle in the local path range or to cope with an instantaneous unexpected accident. Accordingly, there has been suggested a manner of determining the position of the vehicle by applying the fusion of sensors, such as a Light Detection and Ranging (LiDAR) sensor or a radar sensor, and using a precision map.

However, the manner of employing the fusion of the sensors and the precision map largely causes a basic error, and employs a theoretical statistical model based on assumed position estimation logic to make it difficult to verify whether a theoretical statistical model is similar to a real driving condition. In addition, the manner requires a huge computation amount to increase processing time such that the position of the vehicle may not be determined in real time.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an apparatus and a method for determining a position of a vehicle, configured for exactly determining a position of a vehicle for autonomous driving.

The technical problems to be solved as various exemplary embodiments of the present invention are not limited to the aforementioned problems, and any other technical problems not mentioned herein will be clearly understood from the following description by those skilled in the art to which various exemplary embodiments of the present invention pertains.

According to various aspects of the present invention, an apparatus of determining a position of a vehicle, may include a plurality of sensors to acquire raw data for vehicle information and surrounding information related to the vehicle, and a controller to generate a plurality of vehicle position point data based on the raw data, generate respective tracklets for the sensors by combining the plurality of vehicle position point data, fuse the tracklets for the sensor, and determine a final position of the vehicle using the tracklets for the sensors.

The sensor may include an inertia sensor, an image sensor, a position sensor, and a Light Detection and Ranging (LiDAR) sensor.

The controller may be configured to generate the plurality of vehicle position point data, according to raw data, which is acquired by a vehicle speed sensor and a yaw rate sensor included in the inertia sensor, and a position, which is previously determined, of the vehicle, input the vehicle position point data into a buffer memory, combine a predetermined number of the vehicle position point data input into the buffer memory, and generate an inertia sensor tracklet included in the tracklets for the sensors.

The controller may change a sampling rate to a longest time period among input periods of raw data acquired by the inertia sensor, the image sensor, the position sensor, or the LiDAR sensor, and acquire the raw data of the vehicle speed sensor and the yaw rate sensor at the changed sampling rate.

The controller may transform raw data, which is acquired by the position sensor, into local coordinates, generate the vehicle position point data based on the transformed local coordinates, input the vehicle position point data into the buffer memory, combine a predetermined number of the vehicle position point data input into the buffer memory, and generate a position sensor tracklet included in the tracklets for the sensors.

The controller may acquire longitude and latitude coordinates of a building positioned at a distance closest to the vehicle, according to raw data acquired by the image sensor and map information, transform the longitude and latitude coordinates of the building into local coordinates, set an image, which is acquired by the image sensor, of the building as a region of interest, acquire central coordinates of the region of interest, determine position coordinates of the vehicle from the central coordinates, and generate the vehicle position point data based on the position coordinates of the vehicle.

The controller may input the vehicle position point data into the buffer memory, combine a predetermined number of the vehicle position point data input into the buffer memory, and generate an image sensor tracklet included in the tracklets for the sensors.

The controller may acquire longitude and latitude coordinates of a building positioned at a distance closest to the vehicle, according to raw data acquired by the LiDAR sensor and map information, transform the longitude and latitude coordinates of the building into local coordinates, set an image, which is acquired by the LiDAR sensor, of the building as a region of interest, acquire central coordinates of the region of interest, determine position coordinates of the vehicle from the central coordinates, and generate the vehicle position point data based on the position coordinates of the vehicle.

The controller may input the vehicle position point data into the buffer memory, combine a predetermined number of the vehicle position point data input into the buffer memory, and generate a LiDAR sensor tracklet included in the tracklets for the sensors.

The controller may align the tracklets for the sensors, based on a synchronization time, which is preset, and fuse the tracklets for the sensors which are aligned.

The preset synchronization time may include a time at which the tracklets are initially generated.

According to various aspects of the present invention, a method for determining a position of a vehicle, may include acquiring, by a plurality of sensors, raw data for vehicle information and surrounding information related to the vehicle, generating a plurality of vehicle position point data based on the raw data, generating respective tracklets for the sensors by combining the plurality of vehicle position point data, fusing the tracklets for the sensors, and determining a final position of the vehicle using the tracklets for the sensors.

The sensor may include an inertia sensor, an image sensor, a position sensor, and a LiDAR sensor.

The generating of the respective tracklets for the sensors may include generating the plurality of vehicle position point data, according to raw data, which is acquired by a vehicle sensor and a yaw rate sensor included in the inertia sensor, and a position, which is previously determined, of the vehicle, inputting the vehicle position point data into a buffer memory, and combining a predetermined number of the vehicle position point data input into the buffer memory to generate an inertia sensor tracklet included in the tracklets for the sensors.

The generating of the respective tracklets for the sensors may include transforming raw data, which is acquired by the position sensor, into local coordinates, generating the vehicle position point data based on the transformed local coordinates, inputting the vehicle position point data into the buffer memory, combining a predetermined number of the vehicle position point data input into the buffer memory, and generating a position sensor tracklet included in the tracklets for the sensors.

The generating of the respective tracklets for the sensors may include acquiring longitude and latitude coordinates of a building positioned at a distance closest to the vehicle, according to raw data acquired by the image sensor and map information, transforming the longitude and latitude coordinates of the building into local coordinates, setting an image, which is acquired by the image sensor, of the building as a region of interest, acquiring central coordinates of the region of interest, determining position coordinates of the vehicle from the central coordinates, and generating the vehicle position point data based on the position coordinates of the vehicle.

The generating of the respective tracklets for the sensors may include inputting the vehicle position point data into the buffer memory, combining a predetermined number of the vehicle position point data input into the buffer memory, and generating an image sensor tracklet included in the tracklets for the sensors.

The generating of the respective tracklets for the sensors may include acquire longitude and latitude coordinates of a building positioned at a distance closest to the vehicle, according to raw data acquired by the LiDAR sensor and map information, transforming the longitude and latitude coordinates of the building into local coordinates, setting an image, which is acquired by the LiDAR sensor, of the building as a region of interest, acquiring central coordinates of the region of interest, determining position coordinates of the vehicle from the central coordinates, and generating the vehicle position point data based on the position coordinates of the vehicle.

The generating of the respective tracklets for the sensors may include inputting the vehicle position point data into the buffer memory, combining a predetermined number of the vehicle position point data input into the buffer memory, and generating a LiDAR sensor tracklet included in the tracklets for the sensors.

The fusing of the tracklets for the sensors may include aligning the tracklets for the sensors, based on a synchronization time, which is preset, and fusing the tracklets for the sensors which are aligned.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating the configuration of an apparatus of determining a position of a vehicle, according to various exemplary embodiments of the present invention;

FIG. 2 is a view exemplarily illustrating a tracklet generated, according to various exemplary embodiments of the present invention;

FIG. 3 is a view schematically illustrating a manner for transformation into local coordinates, according to various exemplary embodiments of the present invention;

FIG. 4 is a view exemplarily illustrating an operation of extracting a similar tracklet for each sensor, according to various exemplary embodiments of the present invention;

FIG. 5 is a view schematically illustrating an operation for determining a final position of a vehicle, according to various exemplary embodiments of the present invention;

FIG. 6 is a flowchart illustrating a method for determining a position of a vehicle, according to various exemplary embodiments of the present invention;

FIG. 7 is a flowchart illustrating a manner for generating an inertia sensor tracklet, according to various exemplary embodiments of the present invention;

FIG. 8 is a flowchart illustrating a manner for generating a position sensor tracklet, according to various exemplary embodiments of the present invention;

FIG. 9 is a flowchart illustrating a manner for generating a LiDAR sensor tracklet, according to various exemplary embodiments of the present invention;

FIG. 10 is a flowchart illustrating a manner for generating an image sensor tracklet, according to various exemplary embodiments of the present invention; and

FIG. 11 is a block diagram illustrating a computing system to execute the method according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the contrary, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments of the present invention will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present invention, a detailed description of well-known features or functions will be ruled out in order not to unnecessarily obscure the gist of the present invention.

In addition, in the following description of components according to various exemplary embodiments of the present invention, the terms ‘first’, ‘second’, ‘A’, ‘B’, ‘(a)’, and ‘(b)’ may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which various exemplary embodiments of the present invention pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

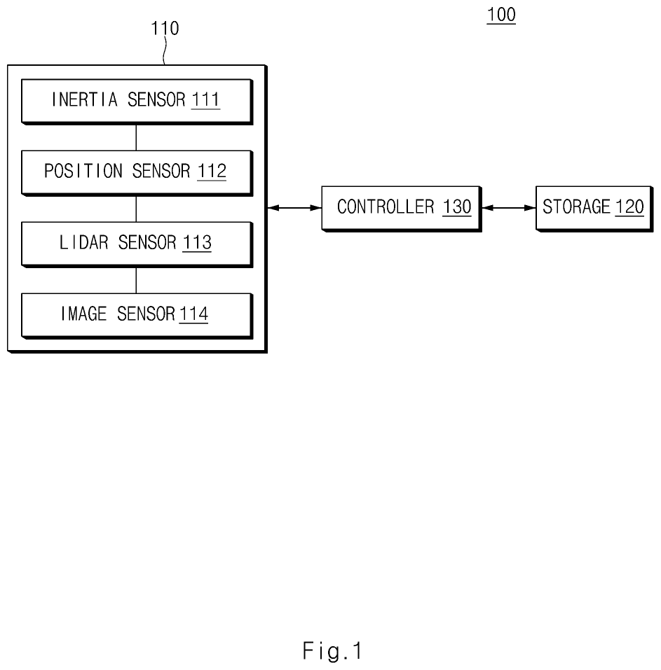

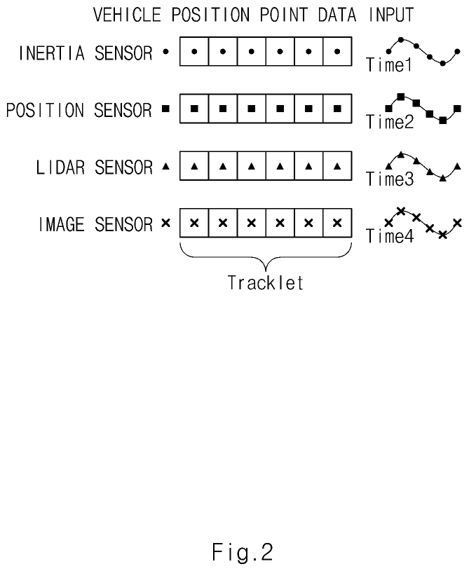

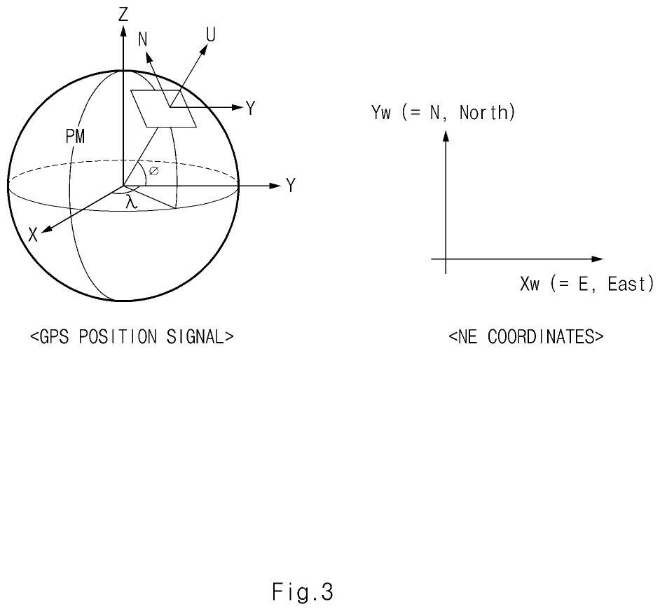

FIG. 1 is a block diagram illustrating the configuration of an apparatus of determining a position of a vehicle, according to various exemplary embodiments of the present invention. FIG. 2 is a view exemplarily illustrating a tracklet generated, according to various exemplary embodiments of the present invention. FIG. 3 is a view schematically illustrating a manner for transformation into local coordinates, according to various exemplary embodiments of the present invention.

As illustrated in FIG. 1, according to various exemplary embodiments of the present invention, an apparatus 100 for determining a position of a vehicle may include a sensor 110 and a controller 130. In the instant case, the sensor 110 may include a plurality of sensors to acquire raw data for vehicle information and surrounding information. According to various exemplary embodiments of the present invention, the sensor 110 may include an inertia sensor 111, a position sensor 112, an image sensor 114, and a Light Detection and Ranging (LiDAR) sensor 113.

The inertia sensor 111 may include a vehicle speed sensor and a yaw rate sensor, and the vehicle speed sensor and the yaw rate sensor may acquire raw data of a vehicle speed and raw data of a yaw rate.

The position sensor 112 may include a global positioning system (GPS) receiver which acquires information on the position of the vehicle, and may acquire raw data for the information on the position of the vehicle.

The LiDAR sensor 113 may acquire raw data for the distance between surrounding obstacles (buildings) of the vehicle. According to various exemplary embodiments of the present invention, LiDAR sensors 113 may be provided at a front portion, a rear portion, a left portion, or a right portion of the vehicle.

The image sensor 114 may include a camera to acquire an image for a surrounding environment of the vehicle, and may include, for example, a complementary metal-oxide-semiconductor (CMOS) or a charged coupled device (CCD). In the instant case, the camera may include a stereo camera for photographing a front portion, a left or right camera, or a rear camera.

The storage 120 may include a main memory and a buffer memory. The main memory may store at least one algorithm to perform operations for various commands or execute the commands to operate the apparatus 100 for determining the position of the vehicle. The buffer memory temporarily may store commands or data transmitted from the main memory to the controller 130, and may smoothly make the flow of information.

The controller 130 may be implemented by various processing devices, such as a microprocessor embedded therein with a semiconductor chip to operate or execute various instructions, and may control the overall operation of the apparatus of determining the position of the vehicle, according to various exemplary embodiments of the present invention. In more detail, the controller 130 may generate a plurality of vehicle position point data based on the raw data acquired by the sensor 110, may generate a tracklet for each of the sensors by combining the plurality of vehicle position point data, may fuse tracklets of the sensors, and may determine the final position of the vehicle using the tracklets for the sensors. In the instant case, the tracklets may refer to a partial track of the vehicle, which is formed by combining the plurality of vehicle position point data.

The controller 130 may generate the vehicle position point data, based on the raw data acquired by each sensor (inertia sensor 111, position sensor 112, LiDAR sensor 113, and image sensor 114).

According to various exemplary embodiments of the present invention, the controller 130 may generate the plurality of vehicle position point data, based on the raw data acquired by the inertia sensor 111 and information on a vehicle position which is previously determined. In the instant case, the controller 130 may change a sampling rate to the longest time period among input periods of the raw data acquired by the inertia sensor 111, the position sensor 112, the LiDAR sensor 113, and the image sensor 114, and may acquire the raw data of the vehicle speed sensor and the yaw rate sensor at the changed sampling rate.

When the vehicle position point data is generated based on the raw data acquired by the inertia sensor 111 and the information on the previously determined final position of the vehicle, the controller 130 may perform a control operation to input the vehicle position point data into the buffer memory. In addition, the controller 130 may generate an inertia sensor tracklet, by combining the specific number of vehicle position point data input into the buffer memory, and may label a time stamp. According to various exemplary embodiments of the present invention, the controller 130 may generate the inertia sensor tracklet by combining five vehicle position point data, and label the inertia sensor tracklet with a first time (time 1) (See FIG. 2).

The controller 130 may transform the raw data obtained by the position sensor 112 into local coordinates, and may generate vehicle position point data, based on the transformed local coordinates. In the instant case, the raw data acquired by the position sensor 112 may include a GPS position signal, and the GPS position signal may include longitude and latitude coordinates (WGS 84). The controller 130 may transform a GPS position signal including longitude and latitude coordinate information into corresponding local coordinates (2D; NE coordinates (N: North and E: East)) (see FIG. 3).

The controller 130 may control to input the vehicle position point data into the buffer memory, when generating the vehicle position point data based on the local coordinates obtained by transforming the raw data acquired by the position sensor 112. In addition, the controller 130 may generate a position sensor tracklet, by combining the specific number of vehicle position point data input into the buffer memory, and may label a time stamp. According to various exemplary embodiments of the present invention, the controller 130 may generate the position sensor tracklet by combining five vehicle position point data, and may label the position sensor tracklet with a second time (time 2) (See FIG. 2).

The controller 130 may select a landmark (building) closest to the vehicle, based on the raw data acquired by the LiDAR sensor 113 and information on a high density map stored in the storage 120. According to various exemplary embodiments of the present invention, the controller 130 may select the landmark (building) closest to the vehicle, based on a GPS position signal, and may acquire a GPS position signal (longitude and latitude coordinates) of the landmark (building). The controller 130 may transform the longitude and latitude coordinates (WGS 84) of the landmark (building) into local coordinates (NE coordinates). The controller 130 may set a landmark image as a region of interest in a LiDAR point cloud acquired by the LiDAR sensor 113, and may acquire coordinates of the central position of the region of interest. The controller 130 may determine position coordinates of the vehicle based on the coordinates of the central position of the region of interest, and may generate vehicle position point data based on the position coordinates of the vehicle. In the instant case, the coordinates of the central position of the region of interest may have local coordinates.

The controller 130 may perform a control operation to input the vehicle position point data into the buffer memory, when generating the vehicle position point data. In addition, the controller 130 may generate an LiDAR sensor tracklet, by combining the specific number of vehicle position point data input into the buffer memory, and may label a time stamp. According to various exemplary embodiments of the present invention, the controller 130 may generate the LiDAR sensor tracklet by combining five vehicle position point data, and label the LiDAR sensor tracklet with a third time (time 3) (See FIG. 2).

The controller 130 may select a landmark (building) closest to the vehicle, based on the raw data acquired by the image sensor 114 and information on a high density map. According to various exemplary embodiments of the present invention, the controller 130 may select the landmark (building) closest to the vehicle, based on a GPS position signal, and may acquire the GPS position signal (longitude and latitude coordinates) of the landmark (building). The controller 130 may transform the longitude and latitude coordinates (WGS 84) of the landmark (building) into local coordinates (NE coordinates). The controller 130 may set a landmark image, which is acquired by the image sensor 114, as a region of interest, and may acquire coordinates of the central position of the region of interest. The controller 130 may determine position coordinates of the vehicle, based on the coordinates of the central position of the region of interest, and may generate vehicle position point data, based on the position coordinates of the vehicle. In the instant case, the coordinates of the central position of the region of interest may have local coordinates.

The controller 130 may perform a control operation to input the vehicle position point data into the buffer memory, when generating the vehicle position point data. In addition, the controller 130 may generate a tracklet of the image sensor, by combining the specific number of vehicle position point data input into the buffer memory, and may label a time stamp. According to various exemplary embodiments of the present invention, the controller 130 may generate a tracklet of the image sensor by combining five vehicle position point data, and label the tracklet of the image sensor with a fourth time (time 4) (See FIG. 2).

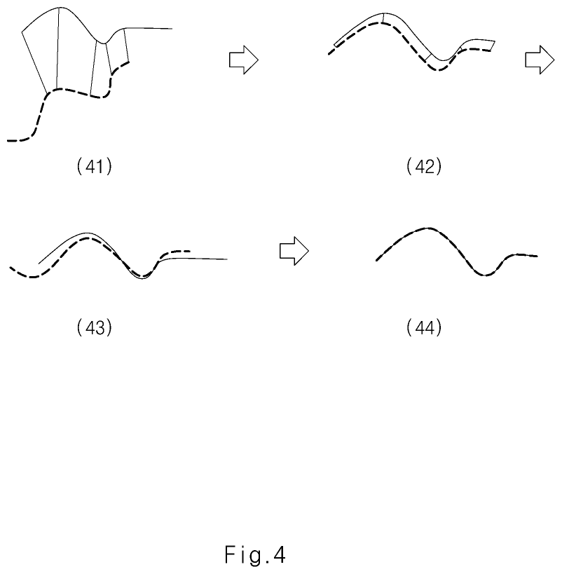

The controller 130 may extract most similar vehicle position point data for the sensors and may combine the vehicle position point data, when generating the tracklet. According to various exemplary embodiments of the present invention, the controller 130 may extract most similar vehicle position point data for the sensors and combine the vehicle position point data, through an interactive closest point (ICP) algorithm. Hereinafter, an operation of generating a tracklet by combining the most similar vehicle position point data for the sensors will be described with reference to FIG. 4.

FIG. 4 is a view exemplarily illustrating the operation of extracting a similar tracklet for each sensor, according to various exemplary embodiments of the present invention.

As illustrated in FIG. 4, the controller 130 extracts closest point among the tracklets for the sensors and connects the closest points with each other (41). The controller 130 may perform translation, rotation, and scaling transformation to minimize a root mean square error of the distance between the points (42). The controller 130 aligns one point of one tracklet with one point of another tracklet (43). The controller 130 may repeat procedures (41) to (43) to extract a similar tracklet for each sensor (44).

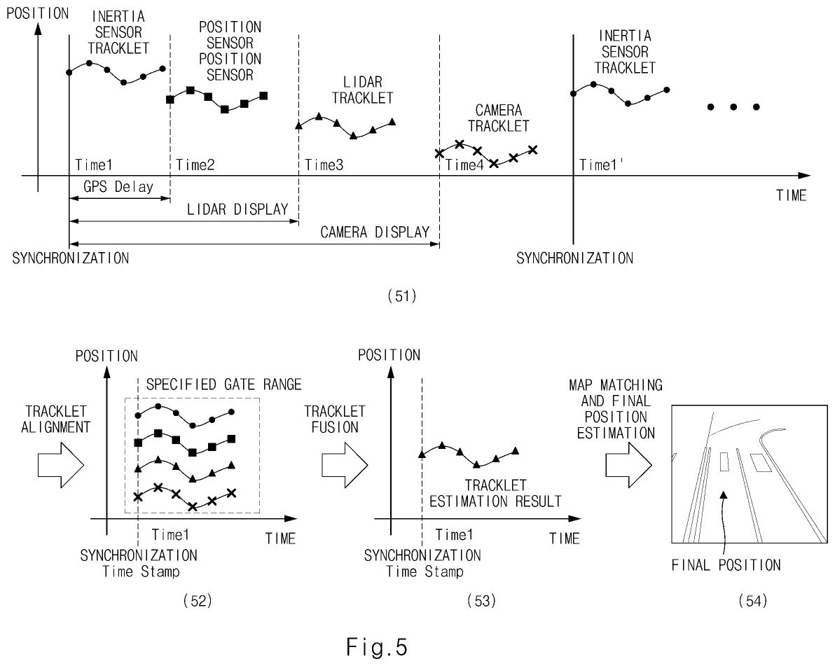

FIG. 5 is a view schematically illustrating an operation for determining a final position of a vehicle, according to various exemplary embodiments of the present invention.

As illustrated in FIG. 5, the controller 130 may generate the tracklets at different times (time 1, time 2, time 3, and time 4) due to the delay time of each sensor (51).

According to various exemplary embodiments of the present invention, the controller 130 may set a synchronization time based on a time in which the tracklet is initially generated such that the tracklets generated at mutually different times are synchronized with each other in time. According to various exemplary embodiments of the present invention, the controller 130 may set ‘time 1’ as the synchronization time, and may align tracklets generated by other sensors, based on the synchronization time (52). In other words, the controller 130 may align the tracklets generated at mutually different times (time 2, time 3, and time 4) due to the delay time of each sensor, based on the time (synchronization time) in which the tracklet is initially generated.

The controller 130 may perform a sensor fusion, when the tracklets generated for the sensors are aligned based on the synchronization time (53). According to various exemplary embodiments of the present invention, the controller 130 may determine an average value of the vehicle position point data generated by the sensors at the same time, by performing the sensor fusion in the preset gate range. For example, the controller 130 may determine an average value of five vehicle position point data, which is included in the tracklet, in the preset gate range.

The controller 130 may match the tracklet subject to the subject fusion to a precision map, and may determine a position, which is matched to the precision map, of the tracklet as the final position of the vehicle (54).

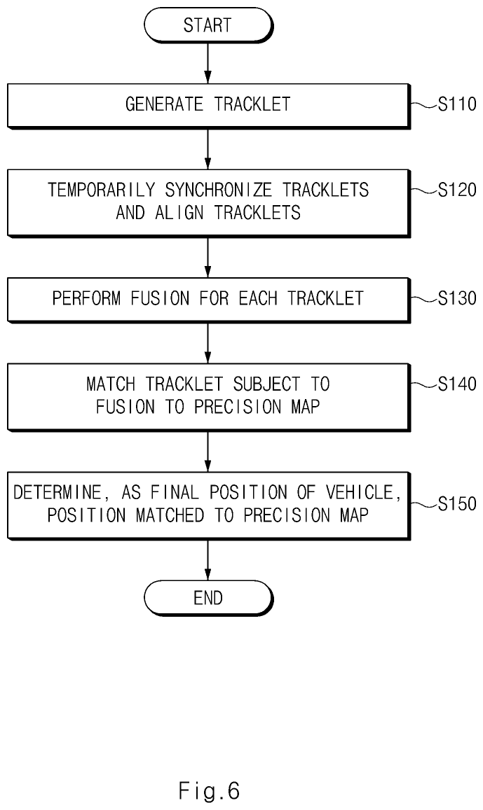

FIG. 6 is a flowchart illustrating a method for determining a position of a vehicle, according to various exemplary embodiments of the present invention.

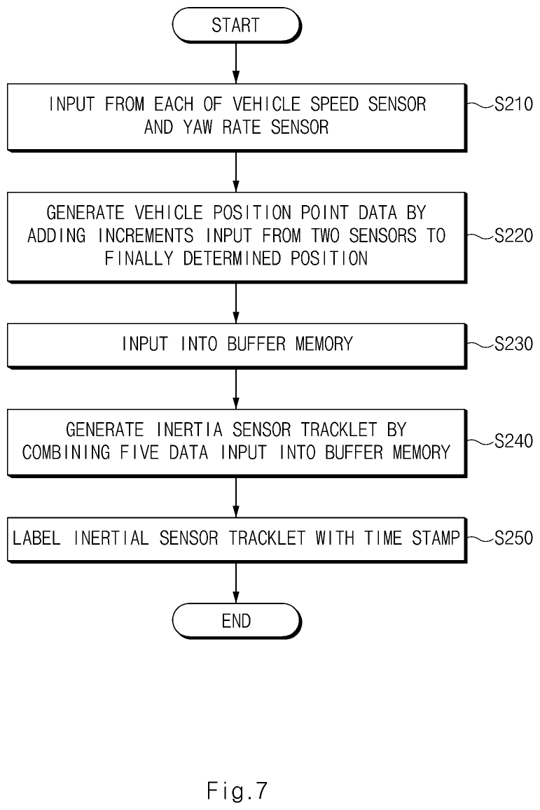

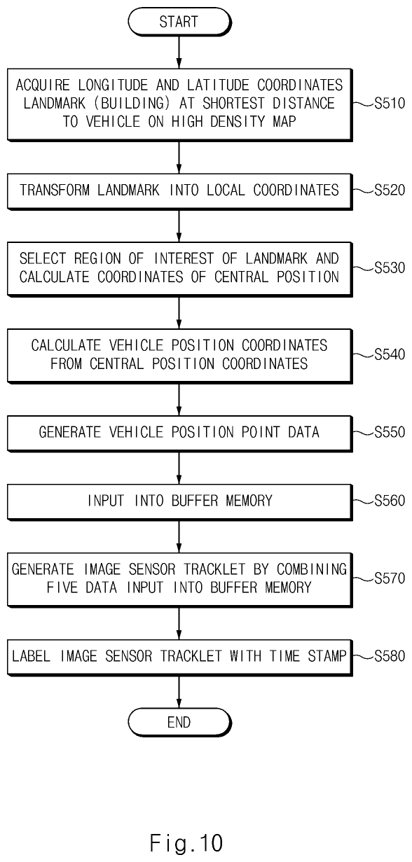

As illustrated in FIG. 6, the controller 130 may generate a tracklet according to the vehicle position point data acquired by each sensor (S110). The details of S110 will be understood by making reference to the description made with reference to FIGS. 7 and 10.

The controller 130 may set a synchronization time and may align the tracklet, based on the set synchronization time, when the tracklet for each sensor is completely generated (S120).

The controller 130 may perform the fusion for the tracklet aligned in S120, may match the tracklet, which is subject to the fusion, to the precision map (S140), and may determine the final position of the vehicle, based on the tracklet matched to the precision map (S150).

FIG. 7 is a flowchart illustrating a manner for generating a tracklet of an inertia sensor, according to various exemplary embodiments of the present invention.

As illustrated in FIG. 7, the controller 130 may receive raw data acquired by the vehicle speed sensor and the yaw rate sensor included in the inertia sensor 111 (S210). In the instant case, the controller 130 may change a sampling rate to the longest time period among input periods of the raw data acquired by the inertia sensor 111, the position sensor 112, the LiDAR sensor 113, and the image sensor 114, and may acquire the raw data of the vehicle speed sensor and the yaw rate sensor at the changed sampling rate.

The controller 130 may generate a plurality of vehicle position point data, based on previously-determined information on a final vehicle position and information input in S210 (S220).

The controller 130 may perform a control operation to input the vehicle position point data, which is generated in S220, into the buffer memory (S230). In addition, the controller 130 may generate an inertia sensor tracklet, by combining the specific number of vehicle position point data input into the buffer memory (S240).

In addition, the controller 130 labels the inertia sensor tracklet with a time stamp (S250). According to various exemplary embodiments of the present invention, the controller 130 may generate a tracklet of the inertia sensor by combining five vehicle position point data, and may label the tracklet of the inertia sensor with a first time (time 1) (See FIG. 2) in S250.

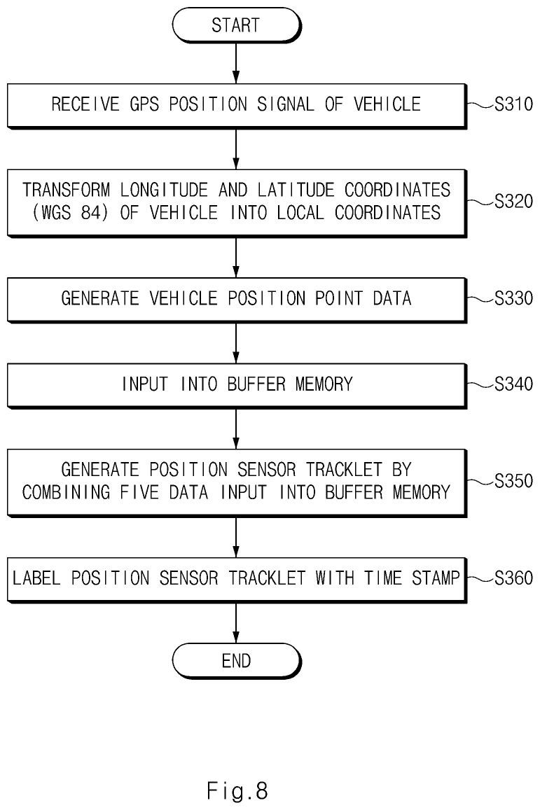

FIG. 8 is a flowchart illustrating a manner for generating a position sensor tracklet, according to various exemplary embodiments of the present invention.

The controller 130 may receive raw data acquired by the position sensor 112 (S310). In the instant case, the raw data acquired by the position sensor 112 may include a GPS position signal, and the GPS position signal may include longitude and latitude coordinates (WGS 84).

The controller 130 may transform the GPS position signal into local coordinates (S320), and may generate vehicle position point data based on the transformed local coordinates (S330). The controller 130 may transform the GPS position signal including longitude and latitude coordinate information into corresponding local coordinates (2D; NE coordinates (N: North, E: East)) (see FIG. 3) in S320.

The controller 130 may perform a control operation to input the vehicle position point data, which is generated in S330, into the buffer memory (S340). In addition, the controller 130 may generate a position sensor tracklet, by combining the specific number of vehicle position point data input into the buffer memory (S350), and may label a time stamp (S360). According to various exemplary embodiments of the present invention, the controller 130 may generate a position sensor tracklet by combining five vehicle position point data, and label the tracklet of the position sensor with a second time (time 2) in S360 (See FIG. 2).

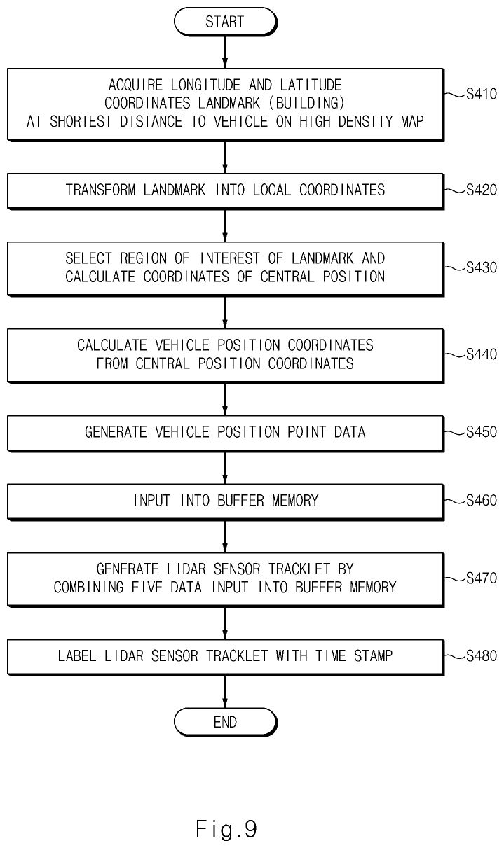

FIG. 9 is a flowchart illustrating a manner for generating a tracklet of a LiDAR sensor, according to various exemplary embodiments of the present invention.

As illustrated in FIG. 9, the controller 130 may select a landmark (building) closest to the vehicle, based on the raw data acquired by the LiDAR sensor 113 and information on a high density map (S410). According to various exemplary embodiments of the present invention, the controller 130 may select the landmark (building) closest to the vehicle, based on a GPS position signal, and may acquire a GPS position signal (longitude latitude coordinates) of the landmark (building) in S410.

The controller 130 may transform the longitude and latitude coordinates (WGS 84) of the landmark (building) into local coordinates (NE coordinates) (S420). The controller 130 may set a landmark image as a region of interest in a LiDAR point cloud acquired by the LiDAR sensor 113, and may acquire coordinates of the central position of the region of interest (S430). In the instant case, the coordinates of the central position of the region of interest may have local coordinates.

The controller 130 may determine position coordinates of the vehicle, based on the coordinates of the central position of the region of interest (S440), and may generate vehicle position point data based on the position coordinates of the vehicle (S450).

The controller 130 may perform a control operation to input the vehicle position point data, which is generated in S450, into the buffer memory (S460). In addition, the controller 130 may generate a LiDAR sensor tracklet, by combining the specific number of vehicle position point data input in the buffer memory (S470), and may label a time stamp (S480). According to various exemplary embodiments of the present invention, the controller 130 may generate the LiDAR sensor tracklet by combining five vehicle position point data, and label the tracklet of the LiDAR sensor with a third time (time 3) (See FIG. 2).

FIG. 10 is a flowchart illustrating a manner for generating an image sensor tracklet, according to various exemplary embodiments of the present invention.

As illustrated in FIG. 10, the controller 130 may select a landmark (building) closest to the vehicle, based on the raw data acquired by the image sensor 114 and information on a high density map (S510). According to various exemplary embodiments of the present invention, the controller 130 may select the landmark (building) closest to the vehicle, based on a GPS position signal, and may acquire a GPS position signal (longitude latitude coordinates) of the landmark (building) in S510.

The controller 130 may transform the longitude and latitude coordinates (WGS 84) of the landmark (building) into local coordinates (NE coordinates) (S520). The controller 130 may set a landmark image acquired by the image sensor 114, and may acquire coordinates of the central position of the region of interest (S530). In the instant case, the coordinates of the central position of the region of interest may have local coordinates.

The controller 130 may determine position coordinates of the vehicle, based on the coordinates of the central position of the region of interest (S540), and may generate vehicle position point data based on the position coordinates of the vehicle (S550).

The controller 130 may perform a control operation to input the vehicle position point data, which is generated in S550, into the buffer memory (S560). In addition, the controller 130 may generate the image sensor tracklet, by combining the specific number of vehicle position point data input into the buffer memory (S570), and may label a time stamp (S580). According to various exemplary embodiments of the present invention, the controller 130 may generate the image sensor tacklet by combining five vehicle position point data, and label the image sensor tracklet with a fourth time (time 4) (See FIG. 2).

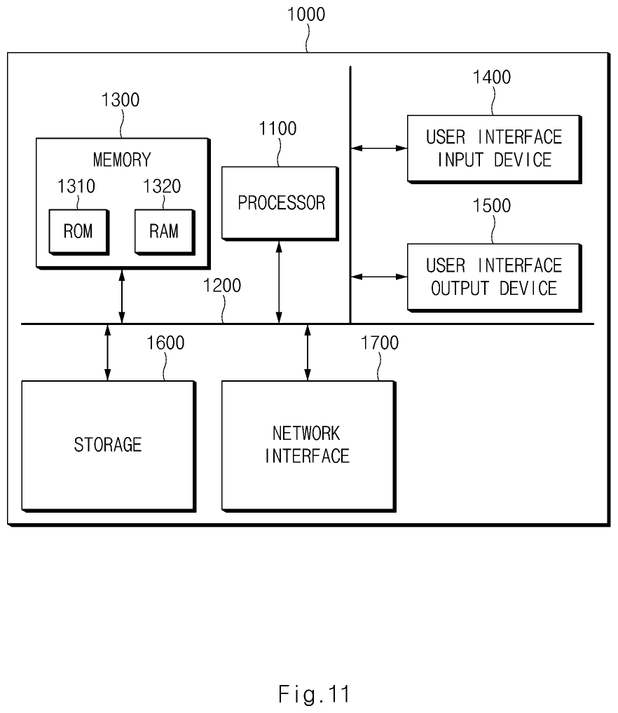

FIG. 11 is a block diagram illustrating a computing system to execute the method according to various exemplary embodiments of the present invention.

Referring to FIG. 11, a computing system 1000 may include at least one processor 1100, a memory 1300, a user interface input device 1400, a user interface output device 1500, a storage 1600, and a network interface 1700, which are connected to each other via a bus 1200.

The processor 1100 may be a central processing unit (CPU) or a semiconductor device configured for processing instructions stored in the memory 1300 and/or the storage 1600. Each of the memory 1300 and the storage 1600 may include various types of volatile or non-volatile storage media. For example, the memory 1300 may include a read only memory (ROM; see 1310) and a random access memory (RAM; see 1320).

Thus, the operations of the methods or algorithms described in connection with the exemplary embodiments included in various exemplary embodiments of the present invention may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

According to various exemplary embodiments of the present invention, in the apparatus and the method for determining the position of the vehicle, the real driving information related to the vehicle and vehicle information are reflected such that the position of the vehicle is more exactly estimated. In addition, the tracklet is stored in the buffer memory, and utilized in estimating the position of the vehicle, preventing a computation amount from being excessively increased such that the position information is acquired in real time.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

In addition, the term of “fixedly connected” signifies that fixedly connected members always rotate at a same speed. Furthermore, the term of “selectively connectable” signifies “selectively connectable members rotate separately when the selectively connectable members are not engaged to each other, rotate at a same speed when the selectively connectable members are engaged to each other, and are stationary when at least one of the selectively connectable members is a stationary member and remaining selectively connectable members are engaged to the stationary member”.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An apparatus of determining a position of a vehicle, the apparatus comprising:
a plurality of sensors configured to acquire raw data for vehicle information and surrounding information related to the vehicle; and
a controller engaged to the plurality of sensors and configured to:
generate a plurality of vehicle position point data according to the raw data;
generate respective tracklets for the plurality of sensors by combining the plurality of vehicle position point data, and fuse the tracklets for the plurality of sensors; and
determine a final position of the vehicle using the tracklets for the plurality of sensors.

2. The apparatus of claim 1, wherein the plurality of sensors includes:
an inertia sensor, an image sensor, a position sensor, and a Light Detection and Ranging (LiDAR) sensor.

3. The apparatus of claim 2, wherein the controller is configured to:
generate the plurality of vehicle position point data, according to raw data, which is acquired by a vehicle speed sensor and a yaw rate sensor included in the inertia sensor, and a position, which is previously determined, of the vehicle;
input the vehicle position point data into a buffer memory;
combine a predetermined number of the vehicle position point data input into the buffer memory; and
generate an inertia sensor tracklet included in the tracklets for the plurality of sensors.

4. The apparatus of claim 3, wherein the controller is configured to:
change a sampling rate to a longest time period among input periods of raw data acquired by the inertia sensor, the image sensor, the position sensor, or the LiDAR sensor; and
acquire the raw data of the vehicle speed sensor and the yaw rate sensor at the changed sampling rate.

5. The apparatus of claim 2, wherein the controller is configured to:
transform raw data, which is acquired by the position sensor, into local coordinates;
generate the vehicle position point data based on the transformed local coordinates;
input the vehicle position point data into a buffer memory;
combine a predetermined number of the vehicle position point data input into the buffer memory; and
generate a position sensor tracklet included in the tracklets for the plurality of sensors.

6. The apparatus of claim 2, wherein the controller is configured to:
acquire longitude and latitude coordinates of a building positioned at a distance closest to the vehicle, according to raw data acquired by the image sensor and map information;
transform the longitude and latitude coordinates of the building into local coordinates;
set an image, which is acquired by the image sensor, of the building as a region of interest;
acquire central coordinates of the region of interest;
determine position coordinates of the vehicle from the central coordinates; and
generate the vehicle position point data based on the position coordinates of the vehicle.

7. The apparatus of claim 6, wherein the controller is configured to:
input the vehicle position point data into a buffer memory;
combine a predetermined number of the vehicle position point data input into the buffer memory; and
generate an image sensor tracklet included in the tracklets for the plurality of sensors.

8. The apparatus of claim 2, wherein the controller is configured to:
acquire longitude and latitude coordinates of a building positioned at a distance closest to the vehicle, according to raw data acquired by the LiDAR sensor and map information;
transform the longitude and latitude coordinates of the building into local coordinates;
set an image, which is acquired by the LiDAR sensor, of the building as a region of interest;
acquire central coordinates of the region of interest;
determine position coordinates of the vehicle from the central coordinates; and
generate the vehicle position point data based on the position coordinates of the vehicle.

9. The apparatus of claim 8, wherein the controller is configured to:
input the vehicle position point data into a buffer memory;
combine a predetermined number of the vehicle position point data input into the buffer memory; and
generate a LiDAR sensor tracklet included in the tracklets for the plurality of sensors.

10. The apparatus of claim 1, wherein the controller is configured to:
align the tracklets for the plurality of sensors, according to a synchronization time, which is preset; and
fuse the aligned tracklets for the plurality of sensors.

11. The apparatus of claim 10, wherein the preset synchronization time includes a time at which the tracklets are initially generated.

12. A method for determining a position of a vehicle, the method comprising:
acquiring, by a plurality of sensors, raw data for vehicle information and surrounding information related to the vehicle;
generating a plurality of vehicle position point data according to the raw data;
generating respective tracklets for the plurality of sensors by combining the plurality of vehicle position point data;
fusing the tracklets for the plurality of sensors; and
determining a final position of the vehicle using the tracklets for the plurality of sensors.

13. The method of claim 12, wherein the plurality of sensors includes:
an inertia sensor, an image sensor, a position sensor, and a Light Detection and Ranging (LiDAR) sensor.

14. The method of claim 13, wherein the generating of the respective tracklets for the plurality of sensors includes:
generating the plurality of vehicle position point data, according to raw data, which is acquired by a vehicle sensor and a yaw rate sensor included in the inertia sensor, and a position, which is previously determined, of the vehicle;
inputting the vehicle position point data into a buffer memory; and
combining a predetermined number of the vehicle position point data input into the buffer memory to generate an inertia sensor tracklet included in the tracklets for the plurality of sensors.

15. The method of claim 13, wherein the generating of the respective tracklets for the plurality of sensors includes:
transforming raw data, which is acquired by the position sensor, into local coordinates;
generating the vehicle position point data based on the transformed local coordinates;
inputting the vehicle position point data into a buffer memory;
combining a predetermined number of the vehicle position point data input into the buffer memory; and
generating a position sensor tracklet included in the tracklets for the plurality of sensors.

16. The method of claim 13, wherein the generating of the respective tracklets for the plurality of sensors includes:
acquiring longitude and latitude coordinates of a building positioned at a distance closest to the vehicle, according to raw data acquired by the image sensor and map information;
transforming the longitude and latitude coordinates of the building into local coordinates;
setting an image, which is acquired by the image sensor, of the building as a region of interest;
acquiring central coordinates of the region of interest;
determining position coordinates of the vehicle from the central coordinates; and
generating the vehicle position point data based on the position coordinates of the vehicle.

17. The method of claim 16, wherein the generating of the respective tracklets for the plurality of sensors includes:
inputting the vehicle position point data into a buffer memory;
combining a predetermined number of the vehicle position point data input into the buffer memory; and
generating an image sensor tracklet included in the tracklets for the plurality of sensors.

18. The method of claim 13, wherein the generating of the respective tracklets for the plurality of sensors includes:
acquire longitude and latitude coordinates of a building positioned at a distance closest to the vehicle, according to raw data acquired by the LiDAR sensor and map information;
transforming the longitude and latitude coordinates of the building into local coordinates;
setting an image, which is acquired by the LiDAR sensor, of the building as a region of interest; acquiring central coordinates of the region of interest;
determining position coordinates of the vehicle from the central coordinates; and
generating the vehicle position point data based on the position coordinates of the vehicle.

19. The method of claim 18, wherein the generating of the respective tracklets for the plurality of sensors includes:
inputting the vehicle position point data into a buffer memory;
combining a predetermined number of the vehicle position point data input into the buffer memory; and
generating a LiDAR sensor tracklet included in the tracklets for the plurality of sensors.

20. The method of claim 12, wherein the fusing of the tracklets for the plurality of sensors includes:
aligning the tracklets for the plurality of sensors, according to a synchronization time, which is preset; and
fusing the aligned tracklets for the plurality of sensors.
